(19) United States
(12) Patent Application Publication
(10) Pub. No.: US 2025/0047459 A1
(43) Pub. Date: Feb. 6, 2025

(54) TIME DIVISION DUPLEXING DOWNLINK-UPLINK CONFIGURATION IMPROVEMENTS

(71) Applicant: QUALCOMM Incorporated, San Diego, CA (US)

(72) Inventors: Jae Ho RYU, San Diego, CA (US); Changhwan PARK, San Diego, CA (US); Pierpaolo VALLESE, Pineto (IT); Prashant SHARMA, San Marcos, CA (US); Md Jahidur RAHMAN, San Diego, CA (US)

(21) Appl. No.: 18/645,115

(22) Filed: Apr. 24, 2024

(30) Foreign Application Priority Data
Aug. 2, 2023 (IT) 102023000016476

(51) Int. Cl. H04L 5/14; H04L 5/00; H04W 72/0446

(52) U.S. Cl. CPC H04L 5/14; H04L 5/0053; H04W 72/0446

(57) ABSTRACT

Certain aspects of the present disclosure provide techniques for improving time division duplexing (TDD) downlink-uplink configuration for new radio (NR) operation with large timing advancements (TAs). An example method by a user equipment (UE) includes transmitting, to a network entity, an indication of a timing advance (TA) value; receiving, from the network entity, information indicating a set of downlink slots of a time division duplexing (TDD) pattern that is dynamically restricted from being scheduled for the UE, wherein the set of downlink slots is based on the TA value; and receiving, from the network entity, downlink transmissions in downlink slots of the TDD pattern except in downlink slots included in the set of downlink slots.

### CROSS-REFERENCE TO RELATED APPLICATIONS

This application claims benefit of and priority to Italy Application No. 102023000016476, filed Aug. 2, 2023, which is hereby assigned to the assignee hereof and hereby expressly incorporated by reference herein in its entirety as if fully set forth below and for all applicable purposes.

### FIELD OF THE DISCLOSURE

Aspects of the present disclosure relate to wireless communications, and more particularly, to techniques for improving time division duplexing (TDD) downlink-uplink configuration for new radio (NR) operation with large timing advancements (TAs).

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a network entity. The method includes receiving an indication of a timing advance (TA) value from a first user equipment (UE); transmitting, to the first UE, information indicating a set of downlink slots of a time division duplexing (TDD) pattern that is dynamically restricted from being scheduled for the first UE, wherein the set of downlink slots is based on the TA value; and transmitting, to the first UE, downlink transmissions in downlink slots of the TDD pattern except in downlink slots included in the set of downlink slots.

Another aspect provides a method for wireless communication by a user equipment (UE). The method includes transmitting, to a network entity, an indication of a timing advance (TA) value; receiving, from the network entity, information indicating a set of downlink slots of a time division duplexing (TDD) pattern that is dynamically restricted from being scheduled for the UE, wherein the set of downlink slots is based on the TA value; and receiving, from the network entity, downlink transmissions in downlink slots of the TDD pattern except in downlink slots included in the set of downlink slots.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example of how a non-stationary relay may be used to extend the coverage area of a network

FIG. 6 depicts an example air to ground (ATG) system.

FIG. 7A includes an example time division duplexing pattern associated with a user equipment with a large time advance.

FIG. 7B includes an example time division duplexing pattern associated with a user equipment with a small time advance.

FIG. 8A includes an example time division duplexing pattern in which a set of downlink slots may be restricted from being scheduled for a UE with a large TA.

FIG. 8B includes an example time division duplexing pattern in which no downlink slots are restricted.

FIG. 9 depicts a process flow for communications in a network between a network entity and a user equipment.

FIG. 10 provides an illustration of different numbers of downlink slots of a time division duplexing pattern that may be included within a set of downlink slots for different timing advance values.

FIG. 11 depicts a method for wireless communications.

FIG. 12 depicts a method for wireless communications.

FIG. 13 depicts aspects of an example communications device.

FIG. 14 depicts aspects of an example communications device.

### DETAILED DESCRIPTION

Aspects of the present disclosure provide apparatuses, methods, processing systems, and computer-readable mediums for improving time division duplexing (TDD) downlink-uplink configuration for new radio (NR) operation with large timing advancements (TAs).

For example, communications in a wireless communications network between a user equipment (UE) and a network entity, such a base station, may be performed according to a time division duplexing (TDD) pattern. This TDD pattern may divide a frequency band on which communications are performed into alternating time slots for transmission and reception, allowing bi-directional communication over a single channel or frequency band. For example, in some cases, the TDD pattern may include a first number of downlink slots configured for downlink transmissions, a second number of uplink slots configured for uplink transmissions, a third number of switching slots configured for downlink-to-uplink switching.

TDD patterns work well for bi-directional communication when the UE is relatively close to the network entity such that there is a small propagation delay between the UE and the network entity. However, there may be scenarios in which some UEs may be located very far from the network entity and, as a result, transmissions between these UEs and the network entity may experience large propagation delays, which may significantly affect downlink and uplink timing of the TDD pattern. For example, in some cases, due to the large propagation delay, uplink transmissions sent by the UE in an uplink slot of the TDD pattern may arrive at the network entity during a downlink slot of the TDD pattern, which may cause interference to downlink transmissions performed by the network entity in this downlink slot.

To help account for these timing errors, the UE may be configured with a timing advance (TA) value, which configures the UE to advance its uplink transmissions by a certain amount of time to ensure that its uplink transmissions are received by the network entity in an uplink slot of TDD pattern. However, advancing the uplink transmissions of the UE according to the TA value may result in these uplink transmissions overlapping with a downlink slot of the TDD pattern. To help account for this advancement in time, the TDD pattern may include a number of switching slots and/or symbols or guard periods in which no transmissions are scheduled and, thus, may be used to advance the uplink transmissions in time without overlapping with downlink transmissions within a downlink slot of the TDD pattern.

In some scenarios, UEs with larger propagation delays may need a larger amount of switching slots and/or symbols or guard periods to account for their larger TA values (e.g., since their uplink transmissions may need to be advanced by a greater amount of time) as compared to UEs with smaller propagation delays and smaller TA values. As a result, it may be beneficial to configure a TDD pattern with a large amount of switching time so that UEs with larger propagation delays and TA values may be accommodated. However, this TDD pattern may be a common TDD pattern that is used by many UEs that are served by the network entity. In some cases, these other UEs may be located closer to the network entity and may have smaller propagation delays, thus requiring less switching slots and/or symbols.

As a result, increasing the amount of switching slots and/or symbols in the TDD pattern to accommodate UEs with larger propagations delays and larger TA values may negatively affect UEs served by the network entity with smaller propagation delays and smaller TA values since the increase of switching slots and/or symbols results in a smaller amount of downlink slots in the TDD pattern. This decrease in downlink slots may, in turn, result in a decrease in throughput in the wireless communications network, which is undesirable. Moreover, increasing the number of switching slots and/or symbols in the TDD pattern may result in a larger TDD pattern periodicity and increased number of hybrid automatic repeat request (HARQ) processes, which may result in unnecessary consumption of processing resources and/or power resources at the UE and unnecessary consumption of time-frequency resources within the wireless communications network.

Accordingly, aspects of the present disclosure provide techniques for improving TDD downlink-uplink configuration in scenarios involving UEs with large round trip delays and corresponding large uplink TAs. For example, rather than using a TDD pattern that includes a relatively large number of switching slots and/or symbols to accommodate UEs with large TAs and round trip delays (and UEs with small TAs/round trip delays), a TDD pattern with a relatively small number of switching slots and/or symbols may instead be used in combination with a dynamic restriction on a number of downlink slots of the TDD pattern that may be scheduled for the UEs with large TAs and propagation delays. Limiting the number of switching slots and/or symbols in the TDD pattern may allow for improved throughput and a lower number of HARQ processes, reducing unnecessary consumption of processing resources and/or power resources at a UE and unnecessary consumption of time-frequency resources within the wireless communications network. Moreover, the dynamic restriction on the number of downlink slots of the TDD pattern may allow for UEs with larger TAs and round trip delays to be accommodated and to avoid overlapping downlink and uplink slots and associated interference.

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

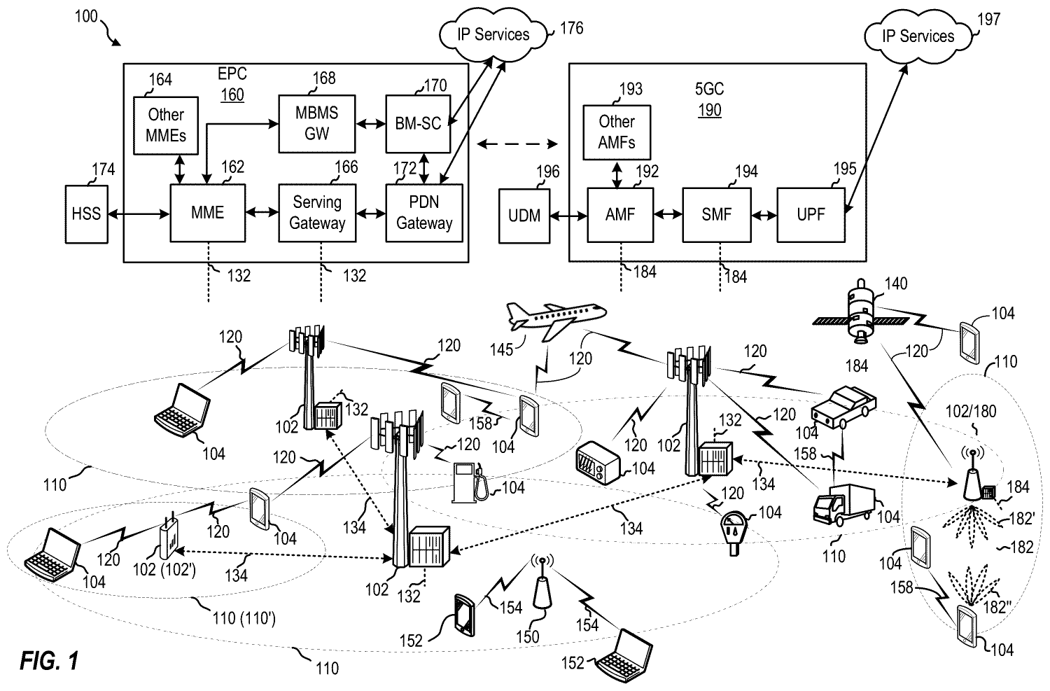

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

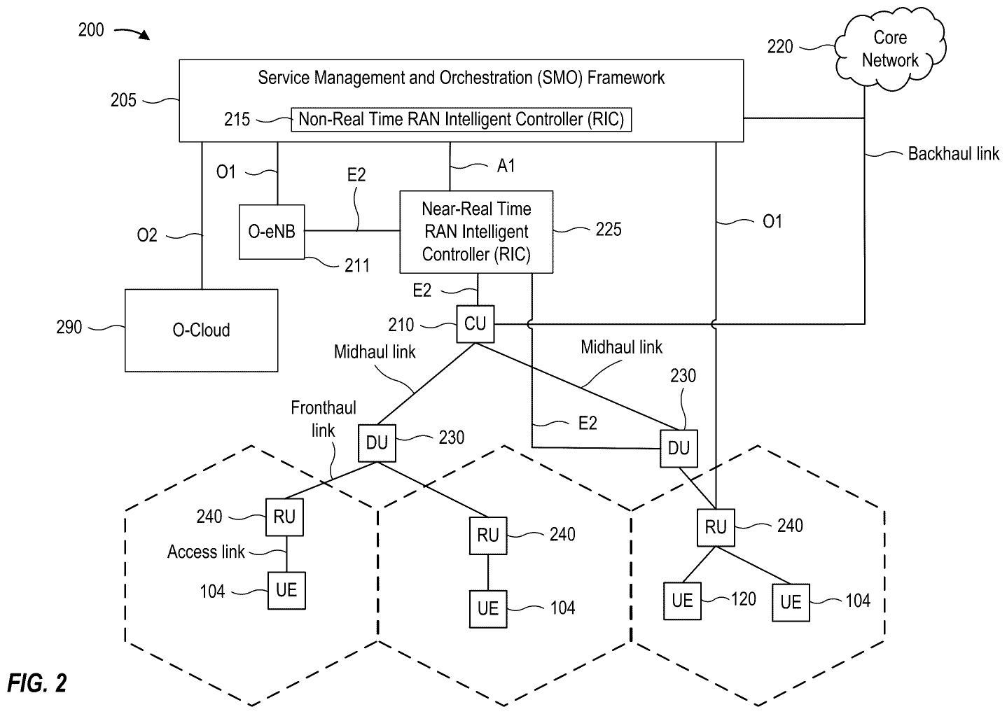

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHZ-71,000 MHZ, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mm Wave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-cNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

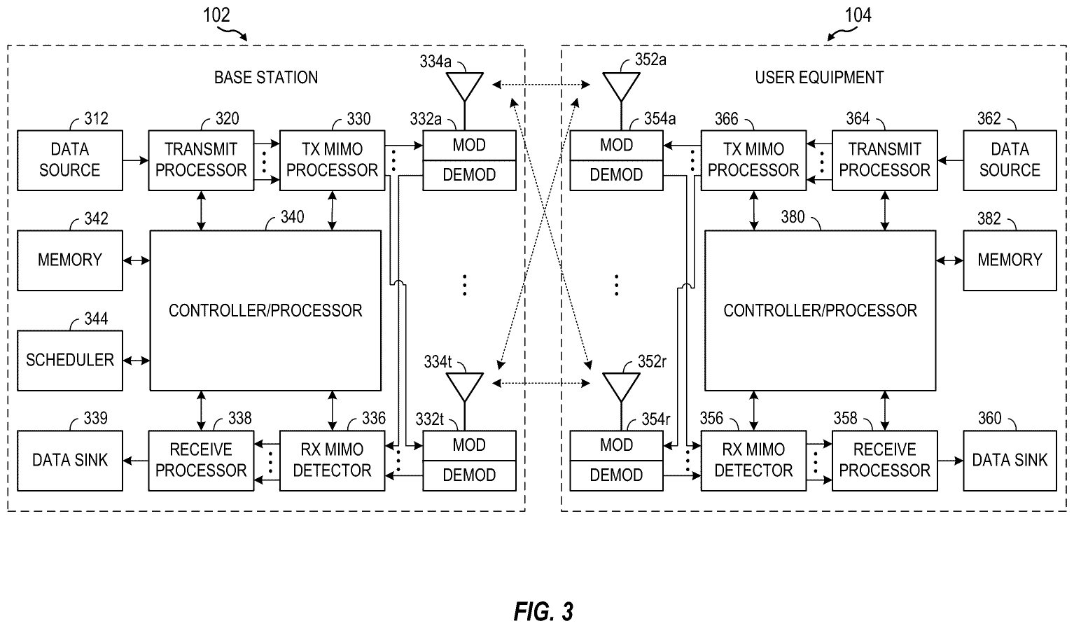

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

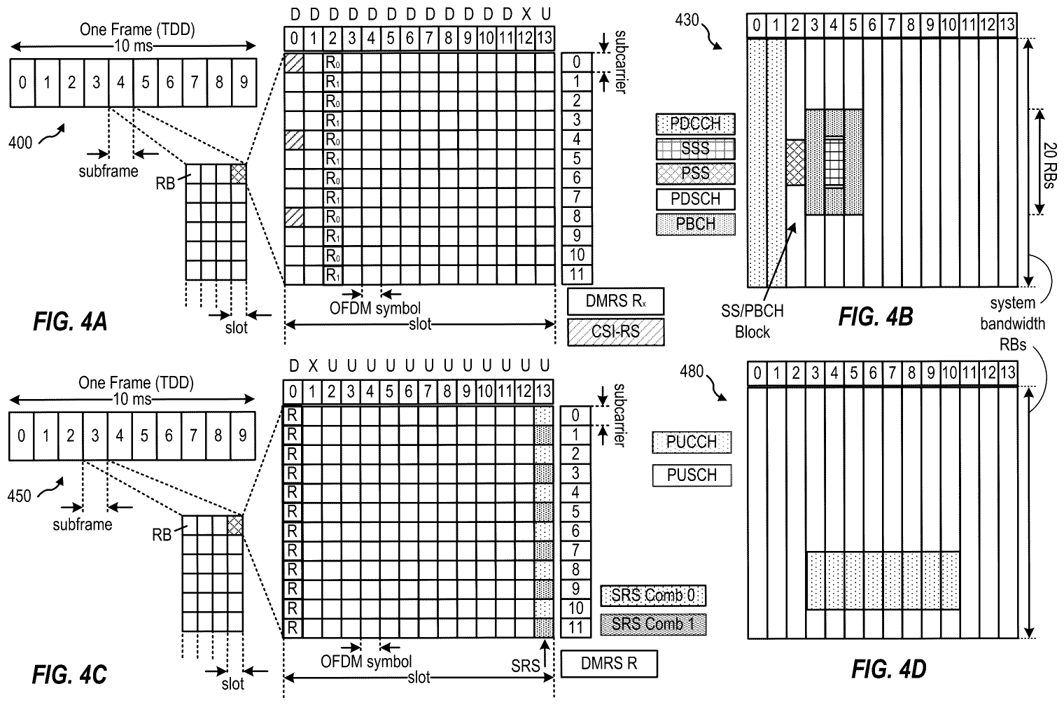

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologics (μ) 0 to 6 allow for 1, 2, 4, 8, 16, 32, and 64 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 6. As such, the numerology μ=0 has a subcarrier spacing of 15 kHz and the numerology μ=6 has a subcarrier spacing of 960 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

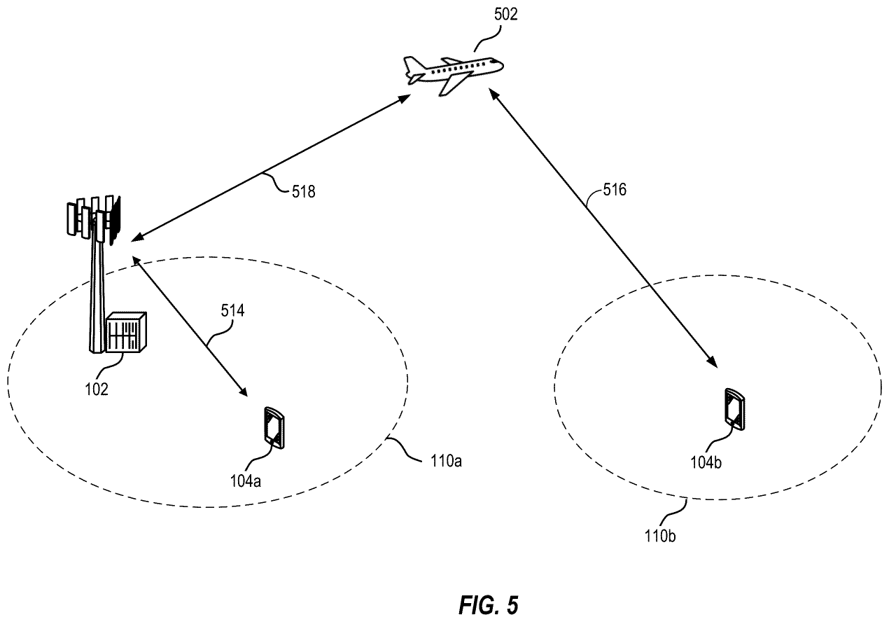

FIG. 5 depicts an example of how a non-stationary relay may be used to extend the coverage area of a network. In the illustrated example, the non-stationary relay is an aircraft 502 which, along with one or more BSs 102, may be part of an air-to-ground (ATG) network.

As shown, BS 102 wirelessly communicates with UE 104a in geographical coverage area 110a via a communications link 514. In particular, BS 102 provides coverage for a wireless communication network in geographical coverage area 110a. Though not shown, the network may include additional BSs 102 providing coverage for the wireless communication network in additional geographical areas. As shown, UE 104b is outside the geographical coverage area of the network, in that it is outside the coverage area of any BS 102.

An aircraft 502 is shown within communication range of BS 102 (e.g., within the coverage area 110a of BS 102). For example, the BS 102 may include one or more up-tilting antennas that can communicate upward to aircraft 502, and aircraft 502 may include one or more bottom/side antennas that can communicate downward. Aircraft 502 and BS 102 may communicate via a communications link 518. In certain aspects, communications between aircraft 502 and BS 102 are beamformed, such as using one or more directional beams. For example, aircraft 502 may use one or more receive beams to receive signals from BS 102, and/or one or more transmit beams to transmit signals to BS 102. Similarly, in an example, BS 102 may use one or more receive beams to receive signals from aircraft 502, and/or one or more transmit beams to transmit signals to aircraft 502. In certain aspects, one or more of BS 102 and aircraft 502 may use an omni-directional beam for transmission and/or reception.

The aircraft may use a relay UE (deployed on the aircraft) to communicate with the BS 102 and with the UE 104b. The relay UE of the aircraft 502 that is used for communications involving the aircraft 502 may include similar components as shown in FIG. 2 as BS 102 and/or UE 104. For example, a controller/processor (e.g., similar to controller/processor 340 and/or 380) of the relay may include a discovery signal component configured to perform one or more operations as discussed herein for broadcasting a discovery signal from an aircraft based at least in part on a geographical location of the aircraft.

The aircraft 502 is able to relay signals between the BS 102 and UEs within one or more additional coverage areas, such as one or more coverage areas outside the coverage area of any BS 102 of the network (e.g., referred to as extended coverage areas). For example, when using beamforming, different transmit and/or receive beams may be used by aircraft 502 to relay signals between the BS 102 and different extended coverage areas. As shown, aircraft 502 is able to extend coverage of the network to an extended coverage area 110b by relaying signals between BS 102 and the UE 104b in the extended coverage area 110b. Accordingly, aircraft 502 is able to extend the coverage of the network to UE 104b in extended coverage area 110b. As shown, aircraft 502 communicates with UE 104b via communications link 516. In certain aspects, communications between aircraft 502 and UE 104b are beamformed, such as using one or more directional beams. For example, aircraft 502 may use one or more receive beams to receive signals from UE 104b, and/or one or more transmit beams to transmit signals to UE 104b. Similarly, in an example, UE 104b may use one or more receive beams to receive signals from aircraft 502, and/or one or more transmit beams to transmit signals to aircraft 502. In certain aspects, one or more of UE 104b and aircraft 502 may use an omni-directional beam for transmission and/or reception.

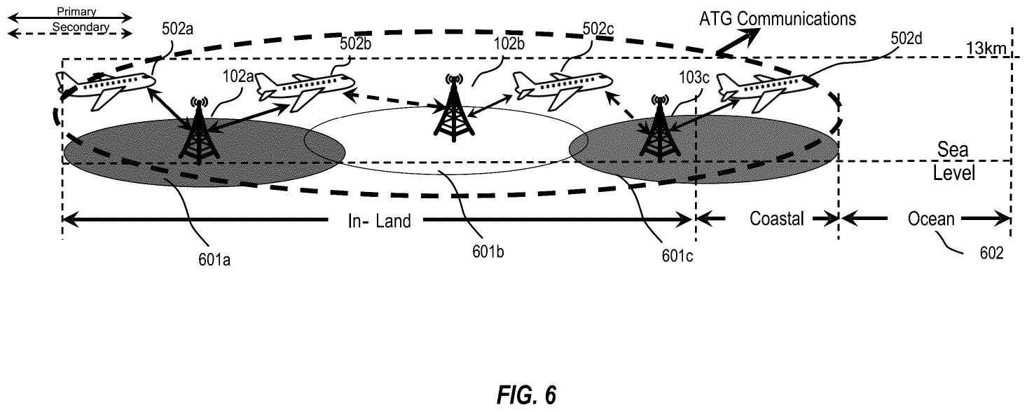

FIG. 6 illustrates how an ATG system may provide network coverage as a UE moves between areas that have terrestrial coverage and areas that lack terrestrial coverage. In the illustrated example, FIG. 6 depicts different coverage areas served by three BSs: a first BS 102a that is associated with the geographical coverage area 601a, a second BS 102b that is associated with the geographical coverage area 601b, and a third BS 102C that is associated with the geographical coverage area 601c. As further depicted in FIG. 6, the first BS 102a and the second BS 102b are in land, while the third BS 102c is on the coast. In some embodiments, each BS 102a-102c is a gNodeB (gNB) that is placed on the ground and has an up-tilting antenna.

FIG. 6 also depicts four aircrafts that communicate with the BSs 102a-102c via ATG communications. The three aircrafts include a first aircraft 502a, a second aircraft 502b, a third aircraft 502c, and a fourth aircraft 502d. As depicted in FIG. 6, each aircraft 502a-502d can communicate with one or more of the BSs 102a-102c through either a primary or a secondary connection as long as the aircraft 502a-502c is within a target distance of the connected BSs and within a threshold altitude (in the exemplary embodiment of FIG. 6, within a threshold altitude of 13 kilometers). Accordingly, as depicted in FIG. 6, the first aircraft 502a can communicate with the first BS 102a, the second aircraft 502b can communicate with first BS 102a and the second BS 102b, the third aircraft 502c can communicate with the second BS 102b and third BS 102c, and the fourth aircraft 502d can communicate with the third BS 102c. In some embodiments, each aircraft 502a-502d may use a relay UE having an antenna at the bottom or on the side of the aircraft 502a-502d to communicate with the BSs that are connected to the aircraft. In some embodiments, some of the communications between the BS 102a-102c and the aircrafts include in-flight passenger communications, airline operation communications, and air traffic control communications.

As depicted in FIG. 6, ATG communications can facilitate communications between remote UEs that are located beyond geographical coverage areas 601a-601c of the BSs 102a-102c by using the aircrafts 502a-502d to relay communications from the remote UEs to BSs 102a-102c. For example, if a remote UE is located within the region 602 in the ocean that falls outside of the geographical coverage area 601c of the third BS 102c, then the remote UE may be able to communicate with the fourth aircraft 502d so that the fourth aircraft 502d relays the communication of the remote UE to the third BS 102c. In this way, the fourth aircraft 502d extends the coverage area of the third BS 102c beyond the geographical coverage area 601c.

As further depicted in FIG. 6, ATG communications can also facilitate communications from a source BS to a destination BS when the source BS falls outside the geographical coverage area of the destination BS. For example, the first BS 102a falls outside of the geographical coverage area 601b of the second BS 102b, which means that the second BS 102b cannot directly receive communications from the first BS 102a. However, the first BS 102a can instead transmit the communications to the second aircraft 502b, which falls within the geographical coverage areas of both the first BS 102a and the second BS 102b, and can thus relay the communications originating from the first BS 102a to the second BS 102b. In this way, the second aircraft 502b extends the coverage area of both the first BS 102a and the second BS 102b.

In some existing deployments of ATG networks, such as those described above in FIGS. 5 and 6, there may be a focus on operation in a time division duplexing (TDD) frequency band. Operation in a TDD frequency band may involve dividing the frequency band into alternating time slots for transmission and reception, allowing bi-directional communication over a single channel or frequency band.

TDD operation works well for allowing bi-directional communication in many scenarios. However, there are some scenarios that present certain issues with TDD operation, such as ATG scenarios. For example, ATG scenarios may involve communication between a stationary, ground-based base station (e.g., BS 102 illustrated in FIG. 5) and a remote UE, such as a UE associated with an aircraft (e.g., aircraft 502 illustrated in FIG. 5). In some cases, this remote UE may comprise a customer premise equipment (CPE) mounted on the aircraft.

In many cases, the remote UE may be located very far from the ground-based base station, such as up to approximately 300 kilometers. In such cases, due to this large distance, transmissions may experience long propagation delays, resulting in large round trip delays for communications between the ground-based base station and the remote UE as compared to UEs located closer to the ground-based base station. For example, in some cases, the round trip delay associated with some remote UEs may be up to about 1.7 milliseconds (ms), representing more than three slots assuming a sub-carrier spacing of 30 kilohertz (kHz).

Large round trip delays may cause issues with TDD patterns or configurations as they may result in a misalignment or overlapping of downlink slots and uplink slots of a TDD pattern. This misalignment can lead to interference and degraded performance. For example, propagation delays can cause an uplink transmission from the remote UE to arrive later than expected at the ground-based base station. As a result, an uplink slot in which the uplink transmission is transmitted may shift, potentially overlapping with a subsequent downlink slot in which a downlink transmission may be transmitted by the ground-based base station, resulting in interference. This interference can lead to corrupted or lost downlink data. Similarly, propagation delays can cause the downlink transmission from the ground-based base station to arrive later than expected at the remote UE. This delay may cause the downlink slot in which the downlink transmission is transmitted to shift, potentially overlapping with a subsequent uplink slot. As a result, the remote UE may transmit in the uplink slot while still receiving the downlink transmission in the downlink slot, causing interference and degradation to the uplink transmission.

In some cases, when receiving downlink transmissions and transmitting uplink transmissions, there may be a certain amount of time that the remote UE needs to switch from a receiving (Rx) mode to a transmitting (Tx) mode, known as an Rx-to-Tx switching time. In some cases, this Rx-to-Tx switching may also contribute to the misalignment/overlapping of downlink slots and uplink slots.

In some cases, to help avoid this misalignment/overlapping of downlink slots and uplink slots (e.g., which may result in colliding downlink and uplink transmissions) an uplink timing advance (TA) may be applied to uplink transmissions at the remote UE. In some cases, the uplink TA may be based on a propagation delay associated with transmissions from the remote UE to the ground-based base station. For example, in some cases, the base station may estimate an expected propagation delay based on factors such as the distance between the device and the base station and the characteristics of the wireless environment. The base station may then instruct the remote UE to transmit its uplink transmissions in an earlier time slot than it would typically use. By shifting the uplink transmission earlier, the remote UE compensates for the expected propagation delay, ensuring that the uplink signal arrives within the corresponding uplink slot at the base station.

In some cases, to help account for the uplink transmissions that are shifted and performed earlier in time, the TDD pattern or configuration may include a number of flexible or switching slots and/or symbols that allow for dynamic adjustment of uplink and downlink timing. For example, in some cases, when the remote UE is instructed to advance its uplink timing, the remote UE may use one or more switching slots and/or symbols (e.g., occurring before configured uplink slots in the TDD configuration) to perform its uplink transmissions such that the uplink transmissions arrive at the base station within the configured uplink slots of the TDD configuration or pattern. These switching slots and/or symbols may also help to account for the Rx-to-Tx switching times at the UE.

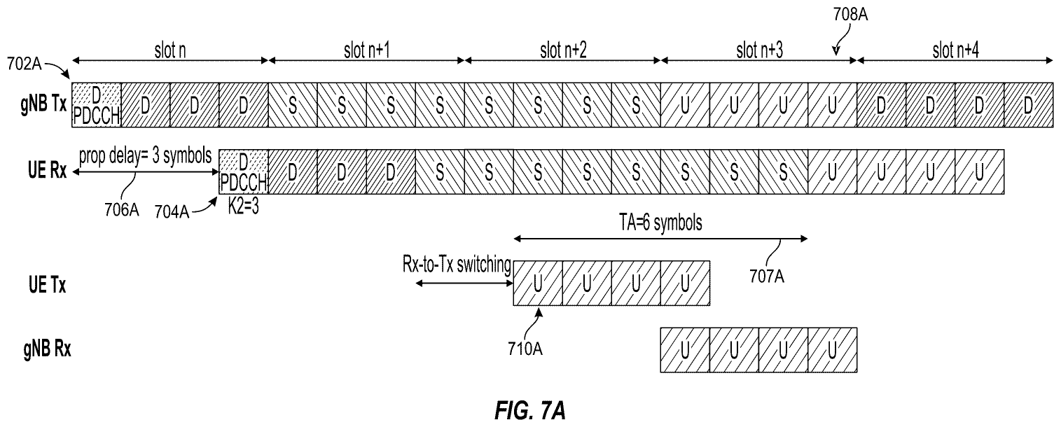

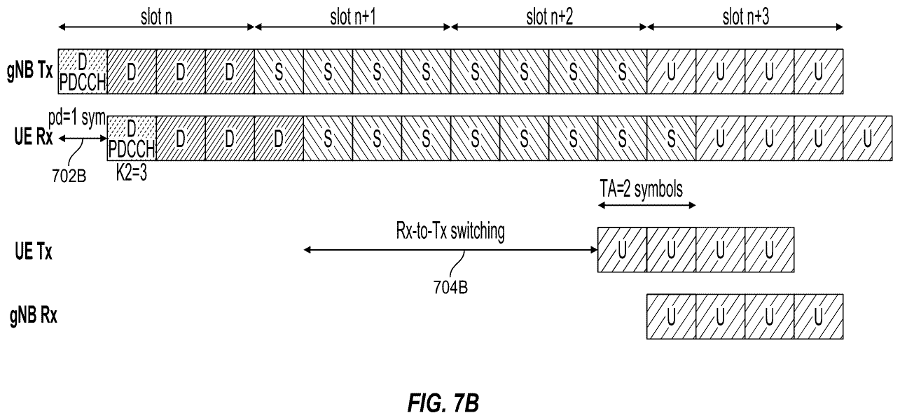

FIG. 7A includes an example TDD pattern illustrating the use of switching slots and/or symbols to help avoid misalignment of downlink slots and uplink slots for a UE with a large propagation delay and corresponding large TA. For example, as shown, the TDD pattern includes a first number of downlink slots (e.g., slot n and slot n+4) each including a plurality of downlink symbols (e.g., labeled D), a second number of switching slots (e.g., slot n+1 and slot n+2) each including a plurality of switching symbols (e.g., labeled S), and a third number of uplink slots (e.g., slot n+3) each including a plurality of uplink symbols (e.g., labeled U).

The representation of the TDD pattern from a base station's (e.g., gNB) perspective is illustrated at 702A and the representation of the TDD pattern from the UE's perspective is illustrated at 704A. As shown, the representation of the TDD pattern from the UE's perspective is shifted relative to the representation of the TDD pattern from the base station's perspective due to a propagation delay associated with transmissions between the base station and UE. For example, as shown at 706A, due to a large distance between the base station and UE, the propagation delay of transmissions between the base station and the UE may be three symbols. As a result, each of the downlink slots, switching slots, and uplink slots in the TDD pattern may be shifted by three symbols from the perspective of the UE.

To help account for this propagation delay and to help ensure uplink transmissions by the UE arrive in the configured uplink slots of the TDD pattern shown in FIG. 7A, the UE may be configured with an uplink TA. As noted above, the uplink TA may configure the UE to perform its uplink transmissions earlier to account for the propagation delay. For example, as shown at 707A in FIG. 7A, the UE may be configured with an uplink TA value of 6 symbols, representing double the 3-symbol propagation delay. Accordingly, rather than beginning its uplink transmissions in a last symbol of slot n+3 of the TDD pattern as illustrated at 708A, which would result in these uplink transmissions overlapping with the downlink symbols of slot n+4, the UE may instead begin its uplink transmissions six symbols earlier in the second switching symbol of switching slot n+2 as illustrated at 710A. By starting its uplink transmissions in the second switching symbol of switching slot n+2, this may allow these uplink transmissions to be received by the base station in the configured uplink slot n+3 of the TDD pattern after the propagation delay of three symbols. Accordingly, as can be seen, the switching slots of the TDD pattern may be used to avoid misalignment or overlapping of downlink slots and uplink slots for UEs having a large propagation delay and corresponding large uplink TA.

In some cases, these switching slots may be unnecessarily long for UEs that may be located closer to the base station (e.g., resulting in shorter propagation delays), as illustrated in FIG. 7B. For example, as shown in FIG. 7B, while transmissions between the UE and the base station may have a relatively short propagation delay (e.g., 1 symbol) as shown at 702B, the UE may end up with an unnecessarily long Rx-to-Tx switching time (e.g., 6 symbols) as shown at 704B.

While the use of uplink TAs and switching slots may help to avoid misalignment of downlink and uplink slots of a TDD pattern or configuration, in many cases there may be a large number of UEs that are served by one base station, each with varying propagation delays and uplink TAs. To help account for this variation in propagation delays and TAs between UEs served by the base station, the TDD pattern may be configured with a relatively large number of switching slots so that even UEs with the largest propagation delays and TAs may be accommodated and the UEs may use the same TDD pattern or configuration. For example, in some cases, to account for round trip delays (e.g., representing twice the propagation delay) of 1.7 ms in ATG scenarios, described above, four switching slots may be allocated in a TDD pattern for ATG scenarios. Alternatively, in some cases, to reduce an overall overhead of these switching slots, the TDD pattern may be configured with a relatively large periodicity of 40 slots.

However, allocating a large number of switching slots in a TDD pattern for ATG scenarios may, in some cases, reduce the amount of downlink and uplink transmissions that may be performed by a base station, resulting in lower throughput. Also, a large TDD pattern periodicity may result in a large physical layer delay in downlink/uplink scheduling and hybrid automatic repeat request (HARQ) operation. Additionally, continuous HARQ scheduling with a large TDD pattern periodicity may require an increased number of HARQ processes, which may result in unnecessary consumption of processing resources and/or power resources at a UE and unnecessary consumption of time-frequency resources within an ATG network.

Accordingly, aspects of the present disclosure provide techniques for improving TDD downlink-uplink configuration in scenarios involving UEs with large round trip delays and corresponding large uplink TAs. For example, rather than using a TDD pattern that includes a relatively large number of switching slots and/or symbols to accommodate UEs with large TAs and round trip delays, a TDD pattern with a relatively small number of switching slots and/or symbols (e.g., 1 slot or 14 symbols) may instead be used in combination with a dynamic restriction on a number of downlink slots of the TDD pattern that may be scheduled for the UEs with large TAs and propagation delays. Limiting the number of switching slots in the TDD pattern may allow for improved throughput and a lower number of HARQ processes, which may reduce unnecessary consumption of processing resources and/or power resources at a UE and unnecessary consumption of time-frequency resources within an ATG network. Moreover, the dynamic restriction on the number of downlink slots of the TDD pattern may allow for UEs with larger TAs and/or round trip delays to be accommodated and to avoid overlapping downlink and uplink slots and associated interference.

For example, in some cases, a network entity, such as a base station, may transmit information to a UE with a large TA and/or round trip delay indicating a set of downlink slots of the TDD pattern that is dynamically restricted from being scheduled for the UE. Thereafter, when scheduled with uplink transmissions in one or more uplink slots of the TDD patterns, the UE may then use downlink slots in the set of downlink slots as pseudo-switching slots to account for the UE's large TA (as well as any necessary Rx-to-Tx switching time) and to perform uplink transmissions, which may avoid any misalignment or overlapping of downlink slots and uplink slots in the TDD pattern while minimizing the number of actual switching slots in the TDD pattern. More specifically, for example, because the set of downlink slots are restricted from being scheduled for the UE, the UE may use the set of downlink slots to advance its uplink timing for scheduled uplink transmissions according to the UE's large TA, which may ensure that these uplink transmissions are received by the network entity within uplink slots that are configured in the TDD pattern.

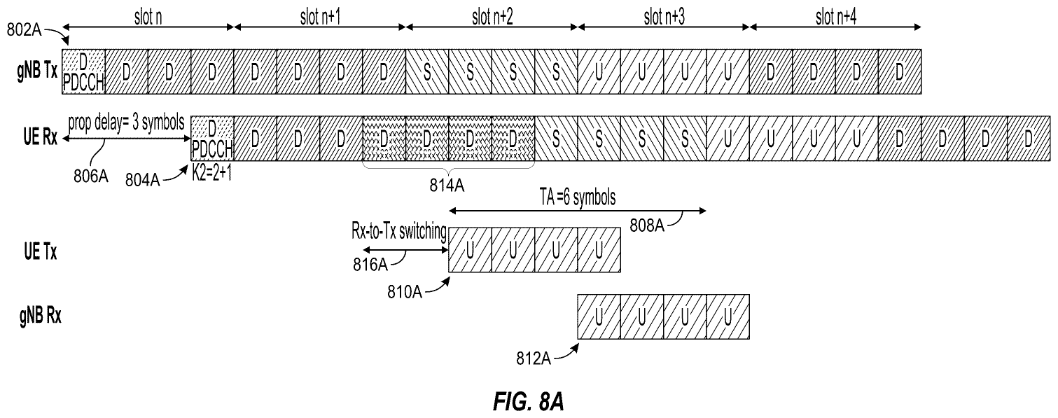

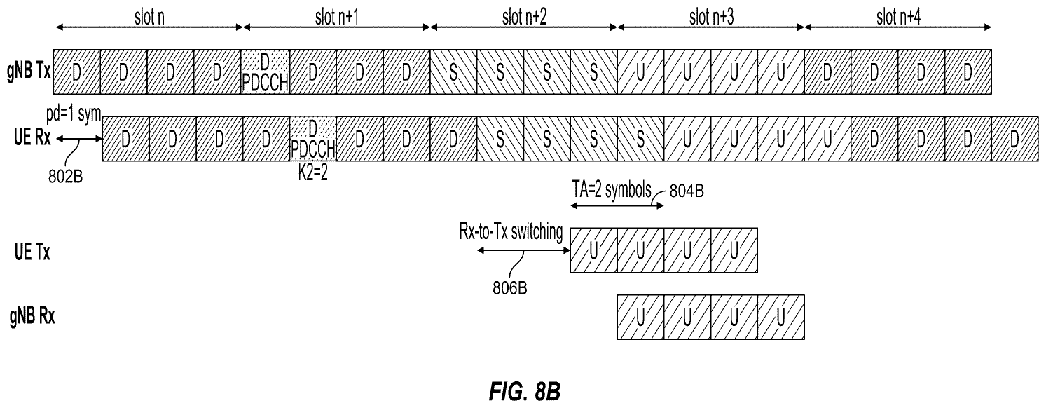

FIG. 8A includes an example TDD pattern used by a network entity (e.g., gNB) and a UE (e.g., a UE associated with an aircraft) in an ATG scenario in which a set of downlink slots may be restricted from being scheduled for a UE with a large TA. The TDD pattern is shown from the network entity's perspective at 802A and from the UE's perspective at 804A.

As shown, the TDD pattern includes a first number of downlink slots configured for downlink transmissions (e.g., slot n, slot n+1, and slot n+4), a second number of uplink slots configured for uplink transmissions (e.g., slot n+3), and a third number of switching slots configured for downlink-to-uplink switching (e.g., slot n+2). Further, the first number of downlink slots may each include a plurality of downlink symbols (e.g., labeled D), the second number of uplink slots may each include a plurality of uplink symbols (e.g., labeled U), and the third number of switching slots may each include a plurality of switching symbols (e.g., labeled S). As shown, the third number of switching slots illustrated in the TDD pattern may only include one switching slot.

Due to a large distance between the UE and the network entity, transmissions between the UE and the network entity may experience a propagation delay of three symbols, as shown at 806A, resulting in the TDD pattern from the UE's perspective being shifted by three symbols relative to the TDD pattern from the network entity's perspective. Further, this propagation delay may result in a round trip delay of six symbols and, consequently, a TA value of six symbols, as shown at 808A.

Due to this relatively large round trip delay, uplink transmissions by the UE would need to be advanced in time by six symbols, as shown at 810A to ensure that these uplink transmissions are received by the network entity in uplink slot n+3 in the TDD pattern, as shown at 812A. Normally, however, advancing these uplink transmissions by the UE would result in these uplink transmissions overlapping with downlink transmissions of slot n+1, causing interference.

To help avoid this interference while also facilitating a minimal number of switching slots to be allocated to the TDD pattern, the network entity may transmit information to the UE indicating a set of downlink slots of the TDD pattern that is dynamically restricted from being scheduled for the UE. In some cases, this set of downlink slots may be based on the TA value of the UE. For example, depending on the TA value of the UE, the set of downlink slots may include different numbers of downlink slots. For example, the set of downlink slots may include a first number of downlink slots when the TA value is less than or equal to a threshold and may include a second number of downlink slots (e.g., greater than the first number of downlink slots) when the TA value is greater than the threshold.

In the example shown in FIG. 8A, the set of downlink slots of the TDD pattern that is dynamically restricted from being scheduled for the UE comprises one slot, as shown at 814A, corresponding to downlink slot n+1. Accordingly, no downlink transmissions may be scheduled by the network entity for the UE within downlink slot n+1, allowing enough time for the UE to switch from a receiving mode to a transmitting mode (e.g., the Rx-to-Tx switching time of two symbols illustrated at 816A) and to advance its uplink transmissions by six symbols, as shown at 810A, to ensure that these uplink transmissions are received by network entity in uplink slot n+3, as shown at 812A.

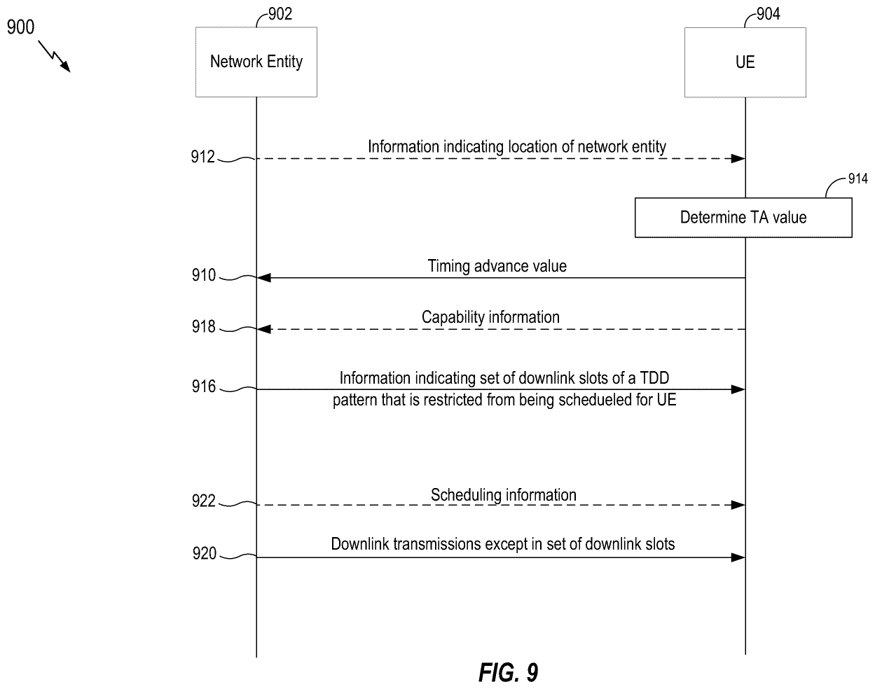

As noted above, depending on the TA value of the UE, the set of downlink slots may include different numbers of downlink slots. FIG. 8B illustrates a TDD pattern in which no downlink slots are restricted. For example, the TDD pattern of FIG. 8B may represent a scenario in which the UE and the network entity are located relatively close together, resulting in a smaller propagation delay and TA value as compared to FIG. 8A. For example, as shown at 802B, the propagation delay between the network entity and the UE is one symbol, resulting in a TA value of two symbols, as shown at 804B. As a result of this relatively small TA value, one switching slot (e.g., slot n+2) is sufficient to account for the UE's 2-symbol TA value illustrated at 804B and 2-symbol Rx-to-Tx switching time illustrated at 806B, allowing the UE to advance its uplink transmissions (e.g., to ensure that these uplink transmissions are received by the network entity in uplink slot n+3) while still allowing the UE to be scheduled in downlink slot n and downlink slot n+1. In other words, due to the UE's relatively small TA value, the set of downlink slots that are restricted from being scheduled for the UE may comprise zero downlink slots since the one switching slot is able to adequately account for the UE's TA value and Rx-to-TX switching time. Additional details regarding these TDD downlink-uplink configuration improvements are discussed below with respect to FIG. 9

FIG. 9 depicts a process flow including operations 900 for communications in a network between a network entity 902 and a user equipment (UE) 904. In some aspects, the network entity 902 may be an example of the BS 102 depicted and described with respect to FIGS. 1 and 3 or a disaggregated base station depicted and described with respect to FIG. 2. Similarly, the UE 904 may be an example of UE 104 depicted and described with respect to FIGS. 1 and 3. However, in other aspects, UE 104 may be another type of wireless communications device and BS 102 may be another type of network entity or network node, such as those described herein. In some cases, the network may comprise an ATG-based network. In such cases, the network entity 902 may comprise a ground-based base station and the UE 904 may comprise a customer premise equipment (CPE) associated with (e.g., mounted on) an aircraft.

As shown in step 910, operations 900 include the UE 904 transmitting a timing advance (TA) value to the network entity 902. In some cases, the TA value may be based on (e.g., and account for) a propagation delay or round trip delay of transmissions between the network entity 902 and UE 904. For example, as described above, the TA value may be used by the UE 904 to advance uplink transmissions in time to account for round trip delay and to ensure that these uplink transmissions are received by the network entity 902 in uplink slots configured in a TDD pattern used for transmissions between the network entity 902 and UE 904.

In some cases, the UE 904 may determine TA value based on information indicating a location of the network entity 902. For example, as shown at 912, the UE 904 may optionally receive information indicating a location of the network entity 902. The UE 904 may then determine a round trip delay of transmissions between the network entity 902 and UE 904 based on the location of the network entity 902 and the UE 904. The round trip delay may be determined based on twice the difference between the location of the network entity 902 and the UE 904 divided by the speed of light. As shown at 914, the UE 904 may then determine the TA value based on the round trip delay.

In some cases, the UE 904 may be configured to perform TA reporting (e.g., involving transmission of the TA value to the network entity 902 at step 910) when a difference between the TA value and a previously reported TA value is larger than a configured TA reporting granularity. In some cases, the configured TA reporting granularity is one slot (e.g., 1 slot=0.5 ms). In some cases, the configured TA reporting granularity is less than one slot (e.g., half slot or quarter slot). For example, in the case where the TA reporting granularity is one slot, if the difference between the TA value and the previously reported TA value is greater than one slot (e.g., 0.5 ms), the UE 904 may transmit the TA value to the network entity 902.

In some cases, the UE 904 may be configured by the network entity 902 with a TDD pattern for communications between the network entity 902 and the UE 904. In some cases, the TDD pattern has a periodicity and, within each period of the periodicity, the TDD pattern may include a first number of downlink slots configured for downlink transmissions, a second number of uplink slots configured for uplink transmissions, and a third number of switching slots configured for downlink-to-uplink switching. In some cases, the number of switching slots may include, for example, one switching slot (e.g., including 14 symbols).

In some cases, the TDD pattern may incur an overlapping of downlink slots and uplink slots in the time domain. In some cases, this overlapping of downlink slots and uplink slots may be based on at least one of a round trip delay between the network entity 902 and UE 904 or a downlink-to-uplink switching delay (e.g., Rx-to-Tx switching time) of the UE 904 (e.g., a time it takes for the UE 904 to switch from a downlink receiving mode to an uplink transmitting mode). In some cases, when the TDD pattern incurs an overlapping of downlink slots and uplink slots, a dynamic scheduling restriction of downlink slots of the TDD pattern that may be scheduled for the UE 904 may be used.

For example, as shown in step 916 of FIG. 9, the UE 904 may receive, from the network entity 902, information indicating a set of downlink slots of the TDD pattern that is dynamically restricted from being scheduled for the UE 904. In some cases, the set of downlink slots is based on the TA value transmitted by the UE 904 to the network entity 902 in step 910. In some cases, the set of downlink slots is further based on a downlink-to-uplink switching delay of the UE. In some cases, as illustrated at 918, the UE 904 may optionally transmit capability information to the network entity 902 indicating the downlink-to-uplink switching delay of the UE 904. In some cases, the downlink-to-uplink switching delay of the UE 904 is pre-configured or based on a wireless communications standard. In some cases, the set of downlink slots of the TDD pattern that is dynamically restricted from being scheduled may be UE-specific (e.g., specific to the UE 904). In some cases, the downlink-to-uplink switching delay may be UE-specifically adapted by the dynamic scheduling restriction of downlink slots of the TDD pattern.

This dynamic downlink scheduling restriction may restrict the set of downlink slots of the TDD pattern that may be scheduled for the UE 904. The set of downlink slots that is restricted from being scheduled for the UE 904 may then be used by the UE 904 to account for the TA value applied by the UE 904 to advance its uplink transmissions as well as the downlink-to-uplink switching delay of the UE 904, as described above with respect to FIG. 8A. In other words, the set of downlink slots of the TDD pattern that is dynamically restricted from being scheduled for the UE is configured for downlink-to-uplink switching and uplink transmissions at the UE 904. As a result, this dynamic scheduling restriction (e.g., the indication of the set of downlink slots that are restricted from being scheduled for the UE 904) may allow the UE 904 to skip downlink signal reception in the indicated set of downlink slots of the TDD pattern when there is scheduled uplink transmission in a subsequent UL slot.

For example, as shown in step 920, due to the dynamic scheduling restriction, the UE 904 may receive, from the network entity 902, downlink transmissions in downlink slots of the TDD pattern except in downlink slots included in the set of downlink slots.

In some cases, the dynamic downlink scheduling restriction may apply to the last X number of downlink slots before a first uplink slot of the TDD pattern. In some cases, the set of downlink slots of the TDD pattern that is dynamically restricted from being scheduled for the UE may comprise a first number of downlink slots when the TA value is less than or equal to a threshold. In some cases, the set of downlink slots of the TDD pattern that is dynamically restricted from being scheduled for the UE may comprise a second number of downlink slots when the TA value is greater than the threshold. In some cases, the first number of downlink slots is less than the second number of downlink slots.

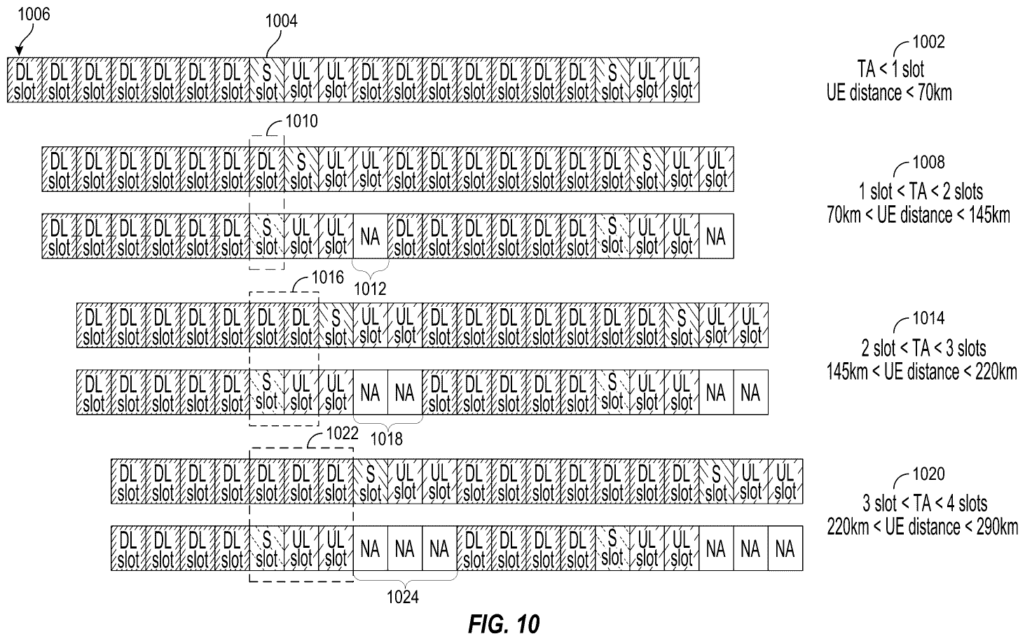

In other words, the number of downlink slots that may be included in the set of downlink slots may depend on the TA value of the UE 904. For example, for larger TA values, the number of downlink slots in the set of downlink slots may be larger as compared to smaller TA values. FIG. 10 provides an illustration of different numbers of downlink slots of the TDD pattern that may be included within the set of downlink slots for different TA values.

For example, as shown at 1002, a distance between the network entity 902 and the UE 904 may be less than 70 kilometers, resulting in a TA value of the UE 904 of less than one slot. Accordingly, in this case, the switching slot 1004 of the TDD pattern is sufficient to account for the UE's downlink-to-uplink switching delay and for the TA value of the UE 904. As a result, the set of downlink slots in the TDD pattern illustrated at 1006 that is dynamically restricted from being scheduled would not include any downlink slots.

In another scenario illustrated at 1008, the distance between the network entity 902 and the UE 904 may be larger than 70 kilometers but less than 145 kilometers, resulting in a TA value of the UE 904 larger than one slot but less than two slots. Accordingly, in this case, to account for the TA value and the downlink-to-uplink switching delay, the set of downlink slots that is dynamically restricted from being scheduled may include one downlink slot, as illustrated at 1010. Further, in this case, the downlink slot illustrated at 1010 may be used by the UE for downlink-to-uplink switching and for advancing its uplink transmissions, resulting in an unused slot at the end of the TDD pattern, shown at 1012 (e.g., labeled N/A or not applicable).

In another scenario illustrated at 1014, the distance between the network entity 902 and the UE 904 may be greater than 145 kilometers but less than 220 kilometers, resulting in a TA value of the UE 904 larger than two slots but less than three slots. Accordingly, in this case, to account for the TA value and the downlink-to-uplink switching delay, the set of downlink slots that is dynamically restricted from being scheduled may include two downlink slots, as illustrated at 1016. Further, in this case, the two downlink slots illustrated at 1016 may be used by the UE for downlink-to-uplink switching and for advancing its uplink transmissions, resulting in two unused slot at the end of the TDD pattern, shown at 1018 (e.g., labeled N/A or not applicable).

In another scenario illustrated at 1020, the distance between the network entity 902 and the UE 904 may be larger than 220 kilometers but less than 290 kilometers, resulting in a TA value of the UE 904 larger than three slots but less than four slots. Accordingly, in this case, to account for the TA value and the downlink-to-uplink switching delay, the set of downlink slots that is dynamically restricted from being scheduled may include three downlink slots, as illustrated at 1022. Further, in this case, the three downlink slots illustrated at 1022 may be used by the UE for downlink-to-uplink switching and for advancing its uplink transmissions, resulting in three unused slot at the end of the TDD pattern, shown at 1024 (e.g., labeled N/A or not applicable).

In some cases, the number of downlink slots that are included within the set of downlink slots and that are restricted from being scheduled for the UE 904 may depend on whether the UE 904 is scheduled with any uplink transmissions. For example, in some cases, if the UE 904 does not have any scheduled or pre-configured uplink transmissions that, based on the TA value, would overlap with the last X number of downlink slots, the UE 904 may be configured to receive downlink transmissions (e.g., PDCCH and/or PDSCH) in those last X number of downlink slots.

For example, as noted above, the TDD pattern may include a first number of downlink slots configured for downlink transmissions, a second number of uplink slots configured for uplink transmissions, and a third number of switching slots configured for downlink-to-uplink switching. In some cases, when the UE 904 is not scheduled to perform any uplink transmissions in the second number of uplink slots, the set of downlink slots of the TDD pattern that is dynamically restricted from being scheduled for the UE comprises zero downlink slots. In this case, based on the set of downlink slots comprising zero downlink slots, each of the downlink slots in the first number of downlink slots are permitted to be scheduled for downlink transmissions to the UE 904. Alternatively, when the UE 904 is scheduled to perform one or more uplink transmissions in the second number of uplink slots, the set of downlink slots of the TDD pattern that is dynamically restricted from being scheduled for the UE comprises one or more downlink slots. In this case, the one or more downlink slots included in set of downlink slots are restricted from being scheduled for the UE 904 to allow the UE 904 to transmit the one or more uplink transmissions.

In some cases, the network entity 902 may be associated with a serving cell comprising a plurality of UEs, including the UE 904. In some cases, the TDD pattern may comprise a common TDD pattern for the plurality of UEs in the serving cell associated with the network entity 902. Further, in some cases, the common TDD pattern may be based on a UE of the plurality of UEs requiring a least number of switching slots for downlink-to-uplink switching and timing advance.

In some cases, the network entity 902 may improve downlink scheduling of the plurality of UEs in the serving cell, including the UE 904, based on TA values of the plurality of UEs. For example, in some cases, the network entity 902 may be configured to schedule UEs, of the plurality of UEs, with large TA values (e.g., UEs that are further away from the network entity 902) in downlink slots occurring earlier in the TDD pattern while scheduling UEs, of the plurality of UEs, with smaller TA values (e.g., UEs that are closer to the network entity 902) in downlink slots occurring later in the TDD pattern. In other words, the network entity 902 may delay downlink transmissions for UEs with smaller TA values to later occurring downlink slots (e.g., in some cases to the restricted downlink slots in the set of downlink slots) such that more downlink data may be transmitted to UEs with larger UEs in earlier occurring downlink slots, which may account for the reduced number of downlink slots that are available for these UEs with larger TA values due to the restricted downlink slots in the set of downlink slots.

Accordingly, in some cases, as illustrated at 922 in FIG. 9, when the TA value of the UE 904 is greater than a threshold, the network entity 902 may optionally transmit scheduling information to the UE 904, scheduling downlink transmissions for the UE 904 in a first set of downlink slots of the first number of downlink slots of the TDD pattern. The first set of downlink slots may occur earlier in time than a second set of downlink slots of the first number of downlink slots. Accordingly, in this case, receiving the downlink transmissions in the downlink slots of the TDD pattern in step 920 of FIG. 9 may include receiving the downlink transmissions in the first set of downlink slots.

In some cases, when the proposed TA value is less than or equal to a threshold, the scheduling information received by the UE 904 in step 922 may schedule the downlink transmissions for the UE 904 in a second set of downlink slots. In this case, the second set of downlink slots may occur later in time than the first set of downlink slots of the first number of downlink slots. Accordingly, in this case, receiving the downlink transmissions in the downlink slots of the TDD pattern in step 920 of FIG. 9 may include receiving the downlink transmissions in the second set of downlink slots.

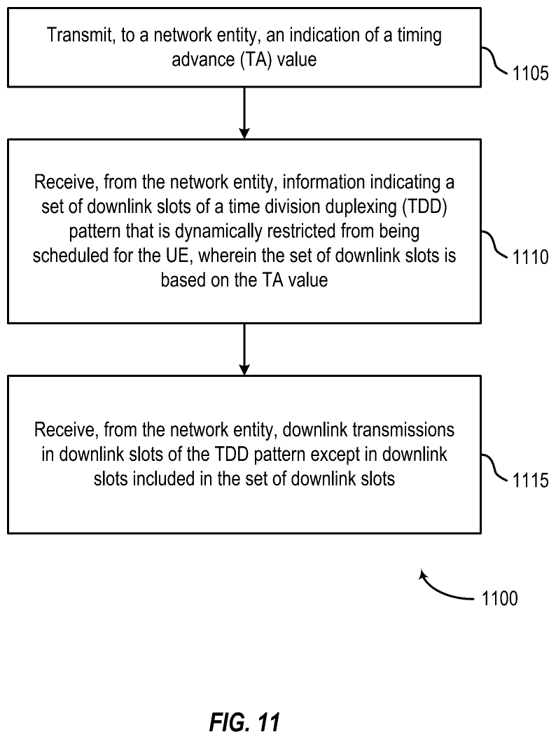

FIG. 11 shows an example of a method 1100 of wireless communication by a user equipment (UE), such as a UE 104 of FIGS. 1 and 3 and/or the UE 904 of FIG. 9

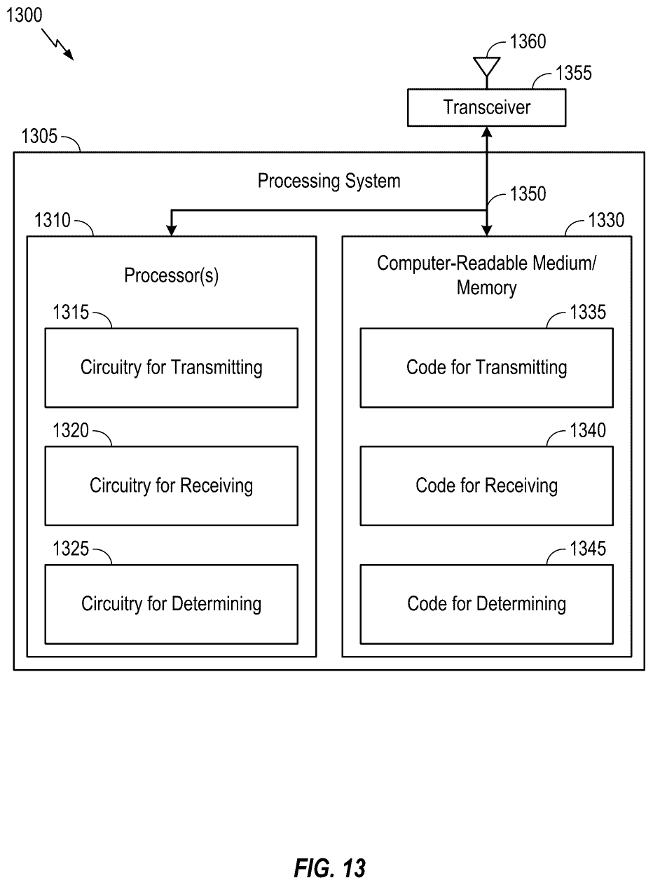

Method 1100 begins at step 1105 with transmitting, to a network entity, an indication of a timing advance (TA) value. For example, the step 1105 may be performed in a manner similar to the aspects described in connection with step 910 of FIG. 9. In some cases, the operations of this step refer to, or may be performed by, circuitry for transmitting and/or code for transmitting as described with reference to FIG. 13.

Method 1100 then proceeds to step 1110 with receiving, from the network entity, information indicating a set of downlink slots of a time division duplexing (TDD) pattern that is dynamically restricted from being scheduled for the UE, wherein the set of downlink slots is based on the TA value. For example, the step 1110 may be performed in a manner similar to the aspects described in connection with step 916 of FIG. 9. In some cases, the operations of this step refer to, or may be performed by, circuitry for receiving and/or code for receiving as described with reference to FIG. 13.

Method 1100 then proceeds to step 1115 with receiving, from the network entity, downlink transmissions in downlink slots of the TDD pattern except in downlink slots included in the set of downlink slots. For example, the step 1115 may be performed in a manner similar to the aspects described in connection with step 920 of FIG. 9. In some cases, the operations of this step refer to, or may be performed by, circuitry for receiving and/or code for receiving as described with reference to FIG. 13.

In some aspects, the TA value is transmitted to the network entity when a difference between the TA value and a previous TA value is greater than a TA reporting granularity.

In some aspects, the TA reporting granularity is one slot.

In some aspects, the TA reporting granularity is less than one slot.

In some aspects, the method 1100 further includes receiving, from the network entity, information indicating a location of the network entity. In some cases, receiving the information indicating the location of the network entity may be performed in a manner similar to the aspects described in connection with reference number 912 of FIG. 9. In some cases, the operations of this step refer to, or may be performed by, circuitry for receiving and/or code for receiving as described with reference to FIG. 13.

In some aspects, the method 1100 further includes determining the TA value based on the location of the network entity and a location of the UE. In some cases, determining the TA value may be performed in a manner similar to the aspects described in connection with reference number 914 of FIG. 9. In some cases, the operations of this step refer to, or may be performed by, circuitry for determining and/or code for determining as described with reference to FIG. 13.

In some aspects, the set of downlink slots of the TDD pattern that is dynamically restricted from being scheduled for the UE is configured for downlink-to-uplink switching and uplink transmissions at the UE.

In some aspects, the set of downlink slots of the TDD pattern that is dynamically restricted from being scheduled for the UE is further based on a downlink-to-uplink switching delay of the UE.

In some aspects, the method 1100 further includes transmitting capability information to the network entity indicating the downlink-to-uplink switching delay of the UE. In some cases, transmitting the capability information may be performed in a manner similar to the aspects described in connection with reference number 918 of FIG. 9. In some cases, the operations of this step refer to, or may be performed by, circuitry for transmitting and/or code for transmitting as described with reference to FIG. 13.

In some aspects, the set of downlink slots of the TDD pattern that is dynamically restricted from being scheduled for the UE comprises: a first number of downlink slots when the TA value is less than or equal to a threshold; and a second number of downlink slots when the TA value is greater than the threshold, wherein the first number of downlink slots is less than the second number of downlink slots.

In some aspects, the TDD pattern has a periodicity and, within each period of the periodicity, the TDD pattern comprises: a first number of downlink slots configured for downlink transmissions; a second number of uplink slots configured for uplink transmissions; and a third number of switching slots configured for downlink-to-uplink switching.

In some aspects, when the UE is not scheduled to perform any uplink transmissions in the second number of uplink slots, the set of downlink slots of the TDD pattern that is restricted from being scheduled for the UE comprises zero downlink slots; and when the UE is scheduled to perform one or more uplink transmissions in the second number of uplink slots, the set of downlink slots of the TDD pattern that is dynamically restricted from being scheduled for the UE comprises one or more downlink slots.

In some aspects, based on the set of downlink slots comprising zero downlink slots, each of the downlink slots in the first number of downlink slots are permitted to be scheduled for downlink transmissions to the UE.

In some aspects, the method 1100 further includes receiving, when the proposed TA value is greater than a threshold, scheduling information from the network entity scheduling downlink transmissions for the UE in a first set of downlink slots of the first number of downlink slots of the TDD pattern, the first set of downlink slots occurring earlier in time than a second set of downlink slots of the first number of downlink slots, wherein: receiving the downlink transmissions in the downlink slots of the TDD pattern comprises receiving the downlink transmissions in the first set of downlink slots. In some cases, receiving the scheduling information may be performed in a manner similar to the aspects described in connection with step 922 of FIG. 9. In some cases, the operations of this step refer to, or may be performed by, circuitry for receiving and/or code for receiving as described with reference to FIG. 13.

In some aspects, the method 1100 further includes receiving, when the proposed TA value is less than or equal to a threshold, scheduling information from the network entity scheduling the downlink transmissions for the UE in a second set of downlink slots, the second set of downlink slots occurring later in time than a first set of downlink slots of the first number of downlink slots, wherein: receiving the downlink transmissions in the downlink slots of the TDD pattern comprises receiving the downlink transmissions in the second set of downlink slots. In some cases, receiving the scheduling information may be performed in a manner similar to the aspects described in connection with step 922 of FIG. 9. In some cases, the operations of this step refer to, or may be performed by, circuitry for receiving and/or code for receiving as described with reference to FIG. 13.

In some aspects, the network entity is associated with a serving cell comprising a plurality of UEs, including the UE; and the TDD pattern comprises a common TDD pattern for the plurality of UEs in the serving cell associated with the network entity; and the common TDD pattern is based on a UE of the plurality of UEs requiring a least number of switching slots for downlink-to-uplink switching and timing advance.

In some aspects, the UE is associated with an aircraft.

In one aspect, method 1100, or any aspect related to it, may be performed by an apparatus, such as communications device 1300 of FIG. 13, which includes various components operable, configured, or adapted to perform the method 1100.

Communications device 1300 is described below in further detail.

Note that FIG. 11 is just one example of a method, and other methods including fewer, additional, or alternative steps are possible consistent with this disclosure.

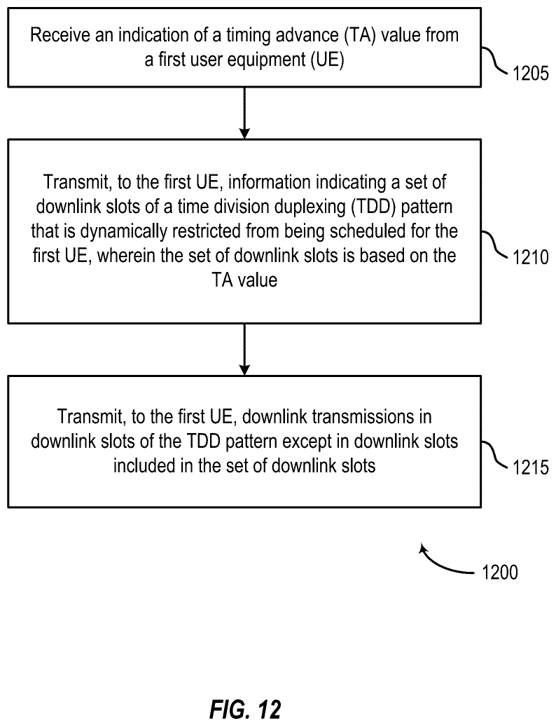

FIG. 12 shows an example of a method 1200 of wireless communication by a network entity, such as a BS 102 of FIGS. 1 and 3, a disaggregated base station as discussed with respect to FIG. 2, or the network entity 902 of FIG. 9.

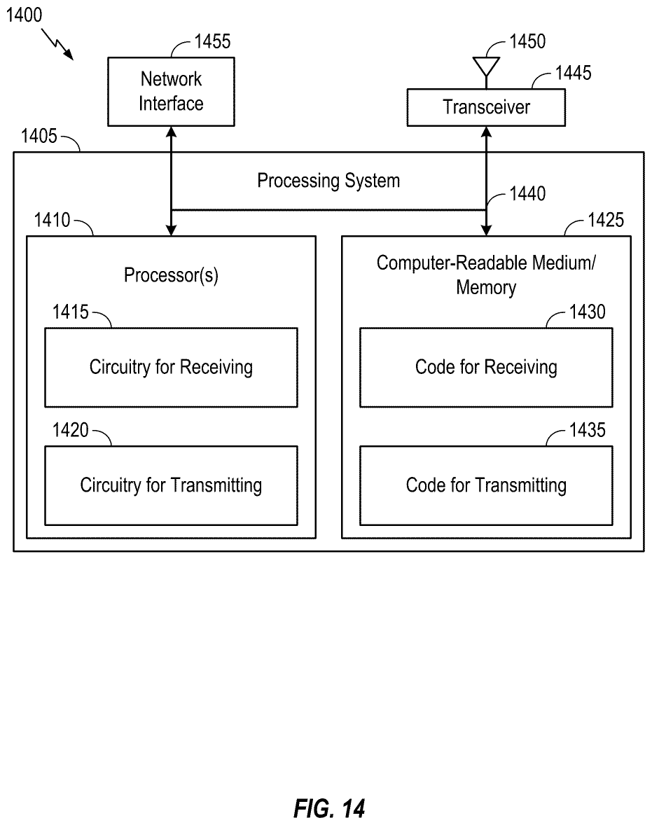

Method 1200 begins at step 1205 with receiving an indication of a timing advance (TA) value from a first user equipment (UE). For example, the step 1205 may be performed in a manner similar to the aspects described in connection with step 910 of FIG. 9. In some cases, the operations of this step refer to, or may be performed by, circuitry for receiving and/or code for receiving as described with reference to FIG. 14.

Method 1200 then proceeds to step 1210 with transmitting, to the UE, information indicating a set of downlink slots of a time division duplexing (TDD) pattern that is dynamically restricted from being scheduled for the UE, wherein the set of downlink slots is based on the TA value. For example, the step 1210 may be performed in a manner similar to the aspects described in connection with step 916 of FIG. 9. In some cases, the operations of this step refer to, or may be performed by, circuitry for transmitting and/or code for transmitting as described with reference to FIG. 14.

Method 1200 then proceeds to step 1215 with transmitting, to the UE, downlink transmissions in downlink slots of the TDD pattern except in downlink slots included in the set of downlink slots. For example, the step 1215 may be performed in a manner similar to the aspects described in connection with step 920 of FIG. 9. In some cases, the operations of this step refer to, or may be performed by, circuitry for transmitting and/or code for transmitting as described with reference to FIG. 14.

In some aspects, the TA value is received from the UE when a difference between the TA value and a previous TA value is greater than a TA reporting granularity.

In some aspects, the TA reporting granularity is one slot.

In some aspects, the TA reporting granularity is less than one slot.

In some aspects, the method 1200 further includes transmitting, to the UE, information indicating a location of the network entity, wherein the TA value is based on the location of the network entity. In some cases, transmitting the information indicating the location of the network entity may be performed in a manner similar to the aspects described in connection with reference number 912 of FIG. 9. In some cases, the operations of this step refer to, or may be performed by, circuitry for transmitting and/or code for transmitting as described with reference to FIG. 14.

In some aspects, the set of downlink slots of the TDD pattern that is dynamically restricted from being scheduled for the UE is configured for downlink-to-uplink switching and uplink transmissions at the UE.

In some aspects, the set of downlink slots of the TDD pattern that is dynamically restricted from being scheduled for the UE is further based on a downlink-to-uplink switching delay of the UE.

In some aspects, the method 1200 further includes receiving capability information from the UE indicating the downlink-to-uplink switching delay of the UE. In some cases, receiving the capability information may be performed in a manner similar to the aspects described in connection with reference number 918 of FIG. 9. In some cases, the operations of this step refer to, or may be performed by, circuitry for receiving and/or code for receiving as described with reference to FIG. 14.

In some aspects, the downlink-to-uplink switching delay of the UE is pre-configured or based on a wireless communications standard.

In some aspects, the set of downlink slots of the TDD pattern that is dynamically restricted from being scheduled for the UE comprises: a first number of downlink slots when the TA value is less than or equal to a threshold; and a second number of downlink slots when the TA value is greater than the threshold, wherein the first number of downlink slots is less than the second number of downlink slots.

In some aspects, the TDD pattern has a periodicity and, within each period of the periodicity, the TDD pattern comprises: a first number of downlink slots configured for downlink transmissions; a second number of uplink slots configured for uplink transmissions; and a third number of switching slots configured for downlink-to-uplink switching.

In some aspects, when the UE is not scheduled to perform any uplink transmissions in the second number of uplink slots, the set of downlink slots of the TDD pattern that is dynamically restricted from being scheduled for the UE comprises zero downlink slots; and when the UE is scheduled to perform one or more uplink transmissions in the second number of uplink slots, the set of downlink slots of the TDD pattern that is dynamically restricted from being scheduled for the UE comprises one or more downlink slots.

In some aspects, the method 1200 further includes transmitting, when the proposed TA value is greater than a threshold, scheduling information to the UE scheduling downlink transmissions for the UE in a first set of downlink slots of the first number of downlink slots of the TDD pattern, the first set of downlink slots occurring earlier in time than a second set of downlink slots of the first number of downlink slots, wherein: transmitting the downlink transmissions in the downlink slots of the TDD pattern comprises transmitting the downlink transmissions in the first set of downlink slots. In some cases, transmitting the scheduling information may be performed in a manner similar to the aspects described in connection with step 922 of FIG. 9. In some cases, the operations of this step refer to, or may be performed by, circuitry for transmitting and/or code for transmitting as described with reference to FIG. 14.

In some aspects, the method 1200 further includes transmitting, when the proposed TA value is less than or equal to a threshold, scheduling information to the UE scheduling the downlink transmissions for the UE in a second set of downlink slots, the second set of downlink slots occurring later in time than a first set of downlink slots of the first number of downlink slots, wherein: transmitting the downlink transmissions in the downlink slots of the TDD pattern comprises transmitting the downlink transmissions in the second set of downlink slots. In some cases, transmitting the scheduling information may be performed in a manner similar to the aspects described in connection with step 922 of FIG. 9. In some cases, the operations of this step refer to, or may be performed by, circuitry for transmitting and/or code for transmitting as described with reference to FIG. 14.

In some aspects, the network entity is associated with a serving cell comprising a plurality of UEs, including the UE; and the TDD pattern comprises a common TDD pattern for the plurality of UEs in the serving cell associated with the network entity; and the common TDD pattern is based on a UE of the plurality of UEs requiring a least number of switching slots for downlink-to-uplink switching and timing advance.

In some aspects, the UE is associated with an aircraft.

In one aspect, method 1200, or any aspect related to it, may be performed by an apparatus, such as communications device 1400 of FIG. 14, which includes various components operable, configured, or adapted to perform the method 1200.

Communications device 1400 is described below in further detail.

Note that FIG. 12 is just one example of a method, and other methods including fewer, additional, or alternative steps are possible consistent with this disclosure.

FIG. 13 depicts aspects of an example communications device 1300. In some aspects, communications device 1300 is a user equipment, such as UE 104 described above with respect to FIGS. 1 and 3.

The communications device 1300 includes a processing system 1305 coupled to the transceiver 1355 (e.g., a transmitter and/or a receiver). The transceiver 1355 is configured to transmit and receive signals for the communications device 1300 via the antenna 1360, such as the various signals as described herein. The processing system 1305 may be configured to perform processing functions for the communications device 1300, including processing signals received and/or to be transmitted by the communications device 1300.

The processing system 1305 includes one or more processors 1310. In various aspects, the one or more processors 1310 may be representative of one or more of receive processor 358, transmit processor 364, TX MIMO processor 366, and/or controller/processor 380, as described with respect to FIG. 3. The one or more processors 1310 are coupled to a computer-readable medium/memory 1330 via a bus 1350. In certain aspects, the computer-readable medium/memory 1330 is configured to store instructions (e.g., computer-executable code) that when executed by the one or more processors 1310, cause the one or more processors 1310 to perform the method 1100 described with respect to FIG. 11, or any aspect related to it. Note that reference to a processor performing a function of communications device 1300 may include one or more processors 1310 performing that function of communications device 1300.

In the depicted example, computer-readable medium/memory 1330 stores code (e.g., executable instructions), such as code for transmitting 1335, code for receiving 1340, and code for determining 1345. Processing of the code for transmitting 1335, code for receiving 1340, and code for determining 1345 may cause the communications device 1300 to perform the method 1100 described with respect to FIG. 11, or any aspect related to it.

The one or more processors 1310 include circuitry configured to implement (e.g., execute) the code stored in the computer-readable medium/memory 1330, including circuitry such as circuitry for transmitting 1315, circuitry for receiving 1320, and circuitry for determining 1325. Processing with circuitry for transmitting 1315, circuitry for receiving 1320, and circuitry for determining 1325 may cause the communications device 1300 to perform the method 1100 described with respect to FIG. 11, or any aspect related to it.

Various components of the communications device 1300 may provide means for performing the method 1100 described with respect to FIG. 11, or any aspect related to it. For example, means for transmitting, sending or outputting for transmission may include transceivers 354 and/or antenna(s) 352 of the UE 104 illustrated in FIG. 3 and/or the transceiver 1355 and the antenna 1360 of the communications device 1300 in FIG. 13. Means for receiving or obtaining may include transceivers 354 and/or antenna(s) 352 of the UE 104 illustrated in FIG. 3 and/or the transceiver 1355 and the antenna 1360 of the communications device 1300 in FIG. 13.

FIG. 14 depicts aspects of an example communications device 1400. In some aspects, communications device 1400 is a network entity, such as BS 102 of FIGS. 1 and 3, or a disaggregated base station as discussed with respect to FIG. 2.

The communications device 1400 includes a processing system 1405 coupled to the transceiver 1445 (e.g., a transmitter and/or a receiver) and/or a network interface 1455. The transceiver 1445 is configured to transmit and receive signals for the communications device 1400 via the antenna 1450, such as the various signals as described herein. The network interface 1455 is configured to obtain and send signals for the communications device 1400 via communication link(s), such as a backhaul link, midhaul link, and/or fronthaul link as described herein, such as with respect to FIG. 2. The processing system 1405 may be configured to perform processing functions for the communications device 1400, including processing signals received and/or to be transmitted by the communications device 1400.

The processing system 1405 includes one or more processors 1410. In various aspects, one or more processors 1410 may be representative of one or more of receive processor 338, transmit processor 320, TX MIMO processor 330, and/or controller/processor 340, as described with respect to FIG. 3. The one or more processors 1410 are coupled to a computer-readable medium/memory 1425 via a bus 1440. In certain aspects, the computer-readable medium/memory 1425 is configured to store instructions (e.g., computer-executable code) that when executed by the one or more processors 1410, cause the one or more processors 1410 to perform the method 1200 described with respect to FIG. 12, or any aspect related to it. Note that reference to a processor of communications device 1400 performing a function may include one or more processors 1410 of communications device 1400 performing that function.

In the depicted example, the computer-readable medium/memory 1425 stores code (e.g., executable instructions), such as code for receiving 1430 and code for transmitting 1435. Processing of the code for receiving 1430 and code for transmitting 1435 may cause the communications device 1400 to perform the method 1200 described with respect to FIG. 12, or any aspect related to it.

The one or more processors 1410 include circuitry configured to implement (e.g., execute) the code stored in the computer-readable medium/memory 1425, including circuitry such as circuitry for receiving 1415 and circuitry for transmitting 1420. Processing with circuitry for receiving 1415 and circuitry for transmitting 1420 may cause the communications device 1400 to perform the method 1200 described with respect to FIG. 12, or any aspect related to it.

Various components of the communications device 1400 may provide means for performing the method 1200 described with respect to FIG. 12, or any aspect related to it. Means for transmitting, sending or outputting for transmission may include transceivers 332 and/or antenna(s) 334 of the BS 102 illustrated in FIG. 3 and/or the transceiver 1445 and the antenna 1450 of the communications device 1400 in FIG. 14. Means for receiving or obtaining may include transceivers 332 and/or antenna(s) 334 of the BS 102 illustrated in FIG. 3 and/or the transceiver 1445 and the antenna 1450 of the communications device 1400 in FIG. 14.

Implementation examples are described in the following numbered clauses:

Clause 1: A method for wireless communication by a network entity, comprising: receiving an indication of a timing advance (TA) value from a first user equipment (UE); transmitting, to the UE, information indicating a set of downlink slots of a time division duplexing (TDD) pattern that is dynamically restricted from being scheduled for the UE, wherein the set of downlink slots is based on the TA value; and transmitting, to the UE, downlink transmissions in downlink slots of the TDD pattern except in downlink slots included in the set of downlink slots.

Clause 2: The method of Clause 1, wherein the TA value is received from the UE when a difference between the TA value and a previous TA value is greater than a TA reporting granularity.

Clause 3: The method of Clause 2, wherein the TA reporting granularity is one slot.

Clause 4: The method of Clause 2, wherein the TA reporting granularity is less than one slot.

Clause 5: The method of any one of Clauses 1-4, further comprising transmitting, to the UE, information indicating a location of the network entity, wherein the TA value is based on the location of the network entity.

Clause 6: The method of any one of Clauses 1-5, wherein the set of downlink slots of the TDD pattern that is dynamically restricted from being scheduled for the UE is configured for downlink-to-uplink switching and uplink transmissions at the UE.

Clause 7: The method of any one of Clauses 1-6, wherein the set of downlink slots of the TDD pattern that is dynamically restricted from being scheduled for the UE is further based on a downlink-to-uplink switching delay of the UE.

Clause 8: The method of Clause 7, further comprising receiving capability information from the UE indicating the downlink-to-uplink switching delay of the UE.

Clause 9: The method of Clause 7, wherein the downlink-to-uplink switching delay of the UE is pre-configured or based on a wireless communications standard.

Clause 10: The method of any one of Clauses 1-9, wherein the set of downlink slots of the TDD pattern that is dynamically restricted from being scheduled for the UE comprises: a first number of downlink slots when the TA value is less than or equal to a threshold; and a second number of downlink slots when the TA value is greater than the threshold, wherein the first number of downlink slots is less than the second number of downlink slots.

Clause 11: The method of any one of Clauses 1-10, wherein the TDD pattern has a periodicity and, within each period of the periodicity, the TDD pattern comprises: a first number of downlink slots configured for downlink transmissions; a second number of uplink slots configured for uplink transmissions; and a third number of switching slots configured for downlink-to-uplink switching.

Clause 12: The method of Clause 11, wherein: when the UE is not scheduled to perform any uplink transmissions in the second number of uplink slots, the set of downlink slots of the TDD pattern that is dynamically restricted from being scheduled for the UE comprises zero downlink slots; and when the UE is scheduled to perform one or more uplink transmissions in the second number of uplink slots, the set of downlink slots of the TDD pattern that is dynamically restricted from being scheduled for the UE comprises one or more downlink slots.

Clause 13: The method of Clause 12, wherein, based on the set of downlink slots comprising zero downlink slots, each of the downlink slots in the first number of downlink slots are permitted to be scheduled for downlink transmissions to the UE.

Clause 14: The method of Clause 11, further comprising: transmitting, when the proposed TA value is greater than a threshold, scheduling information to the UE scheduling downlink transmissions for the UE in a first set of downlink slots of the first number of downlink slots of the TDD pattern, the first set of downlink slots occurring earlier in time than a second set of downlink slots of the first number of downlink slots, wherein: transmitting the downlink transmissions in the downlink slots of the TDD pattern comprises transmitting the downlink transmissions in the first set of downlink slots.

Clause 15: The method of Clause 11, further comprising: transmitting, when the proposed TA value is less than or equal to a threshold, scheduling information to the UE scheduling the downlink transmissions for the UE in a second set of downlink slots, the second set of downlink slots occurring later in time than a first set of downlink slots of the first number of downlink slots, wherein: transmitting the downlink transmissions in the downlink slots of the TDD pattern comprises transmitting the downlink transmissions in the second set of downlink slots.

Clause 16: The method of any one of Clauses 1-15, wherein: the network entity is associated with a serving cell comprising a plurality of UEs, including the UE; and the TDD pattern comprises a common TDD pattern for the plurality of UEs in the serving cell associated with the network entity; and the common TDD pattern is based on a UE of the plurality of UEs requiring a least number of switching slots for downlink-to-uplink switching and timing advance.

Clause 17: The method of any one of Clauses 1-16, wherein the UE is associated with an aircraft.

Clause 18: A method for wireless communication by a user equipment (UE), comprising: transmitting, to a network entity, an indication of a timing advance (TA) value; receiving, from the network entity, information indicating a set of downlink slots of a time division duplexing (TDD) pattern that is dynamically restricted from being scheduled for the UE, wherein the set of downlink slots is based on the TA value; and receiving, from the network entity, downlink transmissions in downlink slots of the TDD pattern except in downlink slots included in the set of downlink slots.

Clause 19: The method of Clause 18, wherein the TA value is transmitted to the network entity when a difference between the TA value and a previous TA value is greater than a TA reporting granularity.

Clause 20: The method of Clause 19, wherein the TA reporting granularity is one slot.

Clause 21: The method of Clause 19, wherein the TA reporting granularity is less than one slot.

Clause 22: The method of any one of Clauses 18-21, further comprising: receiving, from the network entity, information indicating a location of the network entity; and determining the TA value based on the location of the network entity and a location of the UE.

Clause 23: The method of any one of Clauses 18-22, wherein the set of downlink slots of the TDD pattern that is dynamically restricted from being scheduled for the UE is configured for downlink-to-uplink switching and uplink transmissions at the UE.

Clause 24: The method of any one of Clauses 18-23, wherein the set of downlink slots of the TDD pattern that is dynamically restricted from being scheduled for the UE is further based on a downlink-to-uplink switching delay of the UE.

Clause 25: The method of Clause 24, further comprising transmitting capability information to the network entity indicating the downlink-to-uplink switching delay of the UE.

Clause 26: The method of any one of Clauses 18-25, wherein the set of downlink slots of the TDD pattern that is dynamically restricted from being scheduled for the UE comprises: a first number of downlink slots when the TA value is less than or equal to a threshold; and a second number of downlink slots when the TA value is greater than the threshold, wherein the first number of downlink slots is less than the second number of downlink slots.

Clause 27: The method of any one of Clauses 18-26, wherein the TDD pattern has a periodicity and, within each period of the periodicity, the TDD pattern comprises: a first number of downlink slots configured for downlink transmissions; a second number of uplink slots configured for uplink transmissions; and a third number of switching slots configured for downlink-to-uplink switching.

Clause 28: The method of Clause 27, wherein: when the UE is not scheduled to perform any uplink transmissions in the second number of uplink slots, the set of downlink slots of the TDD pattern that is restricted from being scheduled for the UE comprises zero downlink slots; and when the UE is scheduled to perform one or more uplink transmissions in the second number of uplink slots, the set of downlink slots of the TDD pattern that is dynamically restricted from being scheduled for the UE comprises one or more downlink slots.

Clause 29: The method of Clause 28, wherein, based on the set of downlink slots comprising zero downlink slots, each of the downlink slots in the first number of downlink slots are permitted to be scheduled for downlink transmissions to the UE.

Clause 30: The method of Clause 27, further comprising: receiving, when the proposed TA value is greater than a threshold, scheduling information from the network entity scheduling downlink transmissions for the UE in a first set of downlink slots of the first number of downlink slots of the TDD pattern, the first set of downlink slots occurring earlier in time than a second set of downlink slots of the first number of downlink slots, wherein: receiving the downlink transmissions in the downlink slots of the TDD pattern comprises receiving the downlink transmissions in the first set of downlink slots.

Clause 31: The method of Clause 27, further comprising: receiving, when the proposed TA value is less than or equal to a threshold, scheduling information from the network entity scheduling the downlink transmissions for the UE in a second set of downlink slots, the second set of downlink slots occurring later in time than a first set of downlink slots of the first number of downlink slots, wherein: receiving the downlink transmissions in the downlink slots of the TDD pattern comprises receiving the downlink transmissions in the second set of downlink slots.

Clause 32: The method of any one of Clauses 18-31, wherein: the network entity is associated with a serving cell comprising a plurality of UEs, including the UE; and the TDD pattern comprises a common TDD pattern for the plurality of UEs in the serving cell associated with the network entity; and the common TDD pattern is based on a UE of the plurality of UEs requiring a least number of switching slots for downlink-to-uplink switching and timing advance.

Clause 33: The method of any one of Clauses 18-32, wherein the UE is associated with an aircraft.

Clause 34: An apparatus, comprising: one or more memories comprising executable instructions; and one or more processors configured to execute the executable instructions and cause the apparatus to perform a method in accordance with any one of Clauses 1-33.

Clause 35: An apparatus, comprising means for performing a method in accordance with any one of Clauses 1-33.

Clause 36: A non-transitory computer-readable medium comprising executable instructions that, when executed by one or more processors of an apparatus, cause the apparatus to perform a method in accordance with any one of Clauses 1-33.

Clause 37: A computer program product embodied on a computer-readable storage medium comprising code for performing a method in accordance with any one of Clauses 1-33.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

In some cases, rather than actually transmitting a signal, an apparatus (e.g., a wireless node or device) may have an interface to output the signal for transmission. For example, a processor may output a signal, via a bus interface, to a radio frequency (RF) front end for transmission. Accordingly, a means for outputting may include such an interface as an alternative (or in addition) to a transmitter or transceiver. Similarly, rather than actually receiving a signal, an apparatus (e.g., a wireless node or device) may have an interface to obtain a signal from another device. For example, a processor may obtain (or receive) a signal, via a bus interface, from an RF front end for reception. Accordingly, a means for obtaining may include such an interface as an alternative (or in addition) to a receiver or transceiver.

While the present disclosure may describe certain operations as being performed by one type of wireless node, the same or similar operations may also be performed by another type of wireless node. For example, operations performed by a user equipment (UE) may also (or instead) be performed by a network entity (e.g., a base station or unit of a disaggregated base station). Similarly, operations performed by a network entity may also (or instead) be performed by a UE.

Further, while the present disclosure may describe certain types of communications between different types of wireless nodes (e.g., between a network entity and a UE), the same or similar types of communications may occur between same types of wireless nodes (e.g., between network entities or between UEs, in a peer-to-peer scenario). Further, communications may occur in reverse order than described.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. Structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication by a network entity, comprising:
one or more processors configured to execute instructions stored on one or more memories and to cause the network entity to:
receive an indication of a timing advance (TA) value from a first user equipment (UE);
transmit, to the UE, information indicating a set of downlink slots of a time division duplexing (TDD) pattern that is dynamically restricted from being scheduled for the UE, wherein the set of downlink slots is based on the TA value; and
transmit, to the UE, downlink transmissions in downlink slots of the TDD pattern except in downlink slots included in the set of downlink slots.

2. The apparatus of claim 1, wherein:
the TA value is received from the UE when a difference between the TA value and a previous TA value is greater than a TA reporting granularity; and
one of:
the TA reporting granularity is one slot; or
TA reporting granularity is less than one slot.

3. The apparatus of claim 1, wherein the one or more processors are further configured to cause the network entity to transmit, to the UE, information indicating a location of the network entity, wherein the TA value is based on the location of the network entity.

4. The apparatus of claim 1, wherein the set of downlink slots of the TDD pattern that is dynamically restricted from being scheduled for the UE is configured for downlink-to-uplink switching and uplink transmissions at the UE.

5. The apparatus of claim 1, wherein:
the set of downlink slots of the TDD pattern that is dynamically restricted from being scheduled for the UE is further based on a downlink-to-uplink switching delay of the UE; and
one of:
the one or more processors are further configured to cause the network entity to receive capability information from the UE indicating the downlink-to-uplink switching delay of the UE; or
the downlink-to-uplink switching delay of the UE is pre-configured or based on a wireless communications standard.

6. The apparatus of claim 1, wherein the set of downlink slots of the TDD pattern that is dynamically restricted from being scheduled for the UE comprises:
a first number of downlink slots when the TA value is less than or equal to a threshold; and
a second number of downlink slots when the TA value is greater than the threshold, wherein the first number of downlink slots is less than the second number of downlink slots.

7. The apparatus of claim 1, wherein the TDD pattern has a periodicity and, within each period of the periodicity, the TDD pattern comprises:
a first number of downlink slots configured for downlink transmissions;
a second number of uplink slots configured for uplink transmissions; and
a third number of switching slots configured for downlink-to-uplink switching.

8. The apparatus of claim 7, wherein:
when the UE is not scheduled to perform any uplink transmissions in the second number of uplink slots, the set of downlink slots of the TDD pattern that is dynamically restricted from being scheduled for the UE comprises zero downlink slots;
based on the set of downlink slots comprising zero downlink slots, each of the downlink slots in the first number of downlink slots are permitted to be scheduled for downlink transmissions to the UE; and
when the UE is scheduled to perform one or more uplink transmissions in the second number of uplink slots, the set of downlink slots of the TDD pattern that is dynamically restricted from being scheduled for the UE comprises one or more downlink slots.

9. The apparatus of claim 1, wherein:
the network entity is associated with a serving cell comprising a plurality of UEs, including the UE; and
the TDD pattern comprises a common TDD pattern for the plurality of UEs in the serving cell associated with the network entity; and
the common TDD pattern is based on a UE of the plurality of UEs requiring a least number of switching slots for downlink-to-uplink switching and timing advance.

10. The apparatus of claim 1, wherein the UE is associated with an aircraft.

11. An apparatus for wireless communication by a user equipment (UE), comprising:
one or more processors configured to execute instructions stored on one or more memories and to cause the UE to:
transmit, to a network entity, an indication of a timing advance (TA) value;
receive, from the network entity, information indicating a set of downlink slots of a time division duplexing (TDD) pattern that is dynamically restricted from being scheduled for the UE, wherein the set of downlink slots is based on the TA value; and
receive, from the network entity, downlink transmissions in downlink slots of the TDD pattern except in downlink slots included in the set of downlink slots.

12. The apparatus of claim 11, wherein:
the TA value is transmitted to the network entity when a difference between the TA value and a previous TA value is greater than a TA reporting granularity; and
one of:
the TA reporting granularity is one slot; or
the TA reporting granularity is less than one slot.

13. The apparatus of claim 11, wherein the one or more processors are further configured to cause the UE to:
receive, from the network entity, information indicating a location of the network entity; and
determine the TA value based on the location of the network entity and a location of the UE.

14. The apparatus of claim 11, wherein the set of downlink slots of the TDD pattern that is dynamically restricted from being scheduled for the UE is configured for downlink-to-uplink switching and uplink transmissions at the UE.

15. The apparatus of claim 11, wherein:
the set of downlink slots of the TDD pattern that is dynamically restricted from being scheduled for the UE is further based on a downlink-to-uplink switching delay of the UE; and
the one or more processors are further configured to cause the UE to transmit capability information to the network entity indicating the downlink-to-uplink switching delay of the UE.

16. The apparatus of claim 11, wherein the set of downlink slots of the TDD pattern that is dynamically restricted from being scheduled for the UE comprises:
a first number of downlink slots when the TA value is less than or equal to a threshold; and
a second number of downlink slots when the TA value is greater than the threshold, wherein the first number of downlink slots is less than the second number of downlink slots.

17. The apparatus of claim 11, wherein:
the TDD pattern has a periodicity and, within each period of the periodicity, the TDD pattern comprises:
a first number of downlink slots configured for downlink transmissions;
a second number of uplink slots configured for uplink transmissions; and
a third number of switching slots configured for downlink-to-uplink switching;
when the UE is not scheduled to perform any uplink transmissions in the second number of uplink slots, the set of downlink slots of the TDD pattern that is restricted from being scheduled for the UE comprises zero downlink slots;
based on the set of downlink slots comprising zero downlink slots, each of the downlink slots in the first number of downlink slots are permitted to be scheduled for downlink transmissions to the UE; and
when the UE is scheduled to perform one or more uplink transmissions in the second number of uplink slots, the set of downlink slots of the TDD pattern that is dynamically restricted from being scheduled for the UE comprises one or more downlink slots.

18. The apparatus of claim 11, wherein:
the network entity is associated with a serving cell comprising a plurality of UEs, including the UE; and
the TDD pattern comprises a common TDD pattern for the plurality of UEs in the serving cell associated with the network entity; and
the common TDD pattern is based on a UE of the plurality of UEs requiring a least number of switching slots for downlink-to-uplink switching and timing advance.

19. The apparatus of claim 11, wherein the UE is associated with an aircraft.

20. A method for wireless communication by a user equipment (UE), comprising:
transmitting, to a network entity, an indication of a timing advance (TA) value;
receiving, from the network entity, information indicating a set of downlink slots of a time division duplexing (TDD) pattern that is dynamically restricted from being scheduled for the UE, wherein the set of downlink slots is based on the TA value; and
receiving, from the network entity, downlink transmissions in downlink slots of the TDD pattern except in downlink slots included in the set of downlink slots.
